(19) United States
(12) Patent Application Publication
(10) Pub. No.: US 2026/0249549 A1
(43) Pub. Date: Aug. 27, 2026

(54) THREE-DIMENSIONAL PRINTING APPARATUS

(71) Applicant: AtomForm Technology (Shenzhen) Co., Ltd., Shenzhen (CN)

(72) Inventors: Bin LIU, Shenzhen (CN); Jigeng Shang, Shenzhen (CN); Jirong Hu, Shenzhen (CN)

(21) Appl. No.: 19/438,470

(22) Filed: Dec. 31, 2025

Related U.S. Application Data
(63) Continuation of application No. PCT/CN2025/142270, filed on Dec. 12, 2025.

(30) Foreign Application Priority Data
Feb. 21, 2025 (CN) 202510201361.0

(51) Int. Cl. B29C 64/209; B29C 64/336; B33Y 30/00

(52) U.S. Cl. CPC B29C 64/209; B29C 64/336; B33Y 30/00

(57) ABSTRACT

Disclosed is a three-dimensional printing apparatus, including: an extruder formed with a feed channel and provided with a mounting area; and at least two hot ends, each formed with a discharge channel for accommodating a material and provided with an engagement portion, where the engagement portion is adapted to the mounting area of the extruder, and the engagement portions of the different hot ends are detachably connected to the mounting area, so that the feed channel of the extruder is respectively communicated with the discharge channels of the at least two hot ends.

### CROSS-REFERENCE TO RELATED APPLICATIONS

The present application is a continuation of International Application No. PCT/CN2025/142270, filed on Dec. 12, 2025, which claims priority to Chinese Patent Application No. 2025102013610, filed with the China National Intellectual Property Administration on Feb. 21, 2025 and titled “MULTI-DIMENSIONAL PRINTING ASSEMBLY, HOT END, EXTRUDER, AND MULTI-DIMENSIONAL PRINTING APPARATUS”, part of the Chinese Patent Application and the entirety of the International Application are incorporated herein by reference.

### TECHNICAL FIELD

The present application relates to the technical field of multi-dimensional printing and, in particular, to a three-dimensional printing apparatus.

### BACKGROUND

Multi-dimensional printing, such as two-dimensional (2D) or three-dimensional (3D) printing, refers to a method for fabricating models with complex geometric shapes using a single material or multiple materials. Multi-dimensional printing, also known as additive manufacturing, is a technology for producing three-dimensional objects by adding materials layer by layer. Unlike conventional subtractive manufacturing (e.g., cutting, milling), multi-dimensional printing starts from a computer model and constructs objects by gradually accumulating materials. This technology has a wide range of applications, covering multiple fields including manufacturing, healthcare, architecture, art, and education.

During the 3D printing process, it is often necessary to use different materials. In related technologies, the method of switching feed materials through a single tool head is used to meet the demands for different materials. However, the inventor has recognized that this method results in a relatively high waste of material.

### SUMMARY

The present application provides a three-dimensional printing apparatus, which is advantageous for reducing the cost of multi-dimensional printing and the waste of material.

The three-dimensional printing apparatus includes:

an extruder formed with a feed channel and provided with a mounting area; and

at least two hot ends, each formed with a discharge channel for accommodating a material and provided with an engagement portion, where the engagement portion is adapted to the mounting area of the extruder, and the engagement portions of the different hot ends are detachably connected to the mounting area, so that the feed channel of the extruder is respectively communicated with the discharge channels of the at least two hot ends, thereby enabling the extruder to convey the material into the discharge channels of the hot ends.

In an embodiment of the present application, the extruder is provided with a connection end for connecting with the hot end, the mounting area includes a mounting space formed at the connection end of the extruder, a shape of the engagement portion is adapted to the mounting space, and the engagement portion is accommodated within the mounting space.

In an embodiment of the present application, the connection end includes a first connection portion and a second connection portion connected sequentially, the first connection portion extends along a first direction, the second connection portion extends along a second direction, the first direction and the second direction intersect, and the mounting space is formed between the first connection portion and the second connection portion.

In an embodiment of the present application, the extruder includes a connecting member, the connecting member is arranged at the mounting area, and when the hot end is located at the mounting area, the connecting member is configured to fixedly connect the hot end and the extruder.

In an embodiment of the present application, the three-dimensional printing apparatus further includes at least one positioning member, the positioning member is arranged at the mounting area and is configured to position the engagement portion to allow the engagement portion to cooperate with and be fixed to the mounting area, the engagement portion is formed with a positioning hole, and the positioning member is insertable into the positioning hole to position and fix the engagement portion.

In an embodiment of the present application, nozzles of the different hot ends have different apertures.

In an embodiment of the present application, at least one of the feed channel and the discharge channel is a linear channel.

In an embodiment of the present application, the hot end includes a heating portion and a nozzle connected sequentially, the discharge channel includes a first channel formed in the heating portion, and the first channel communicates the nozzle with the feed channel.

In an embodiment of the present application, the hot end further includes a heat dissipation portion, the heat dissipation portion, the heating portion, and the nozzle are connected sequentially, the discharge channel further includes a second channel formed in the heat dissipation portion, and the second channel and the first channel are in communication.

In an embodiment of the present application, the heat dissipation portion includes a heat dissipation frame and a heat dissipation body, the heat dissipation body is installed on the heat dissipation frame, the heat dissipation frame is formed with a connection hole, a first end of the heating portion is connected to the heat dissipation body, a second end of the heating portion passes through the connection hole and protrudes beyond the heat dissipation frame, and the connection hole limits and guides the heating portion to communicate and align the first channel with the second channel.

In an embodiment of the present application, the heating portion is detachably connected to the heat dissipation frame.

### BRIEF DESCRIPTION OF DRAWINGS

To describe the technical solutions in the embodiments of the present application more clearly, the accompanying drawings required to describe the embodiments will be briefly described below. Apparently, the accompanying drawings described below merely illustrate some embodiments of the present application. Those skilled in the art may further derive other drawings from these accompanying drawings without making creative efforts.

FIG. 1 is a schematic structural diagram of a three-dimensional printing apparatus according to the present application;

FIG. 2 is a first exploded structural diagram of the three-dimensional printing apparatus according to the present application;

FIG. 3 is a second exploded structural diagram of the three-dimensional printing apparatus according to the present application;

FIG. 4 is a first schematic structural diagram of a hot end according to the present application;

FIG. 5 is a schematic structural diagram of the hot end according to the present application, where an item located below a nozzle is a printed product;

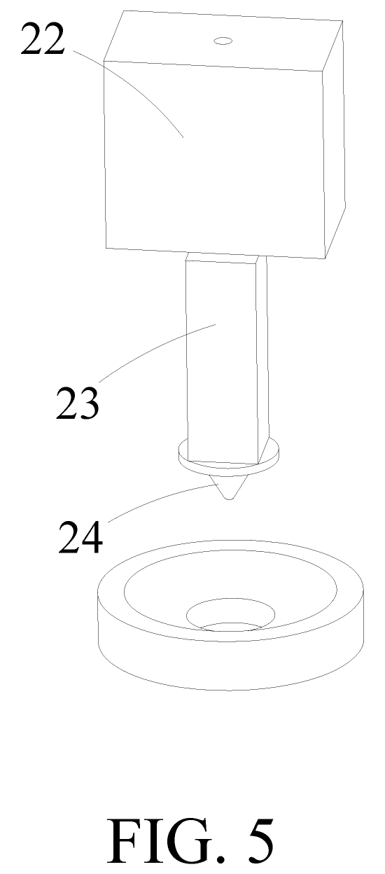

FIG. 6 is a schematic structural diagram of a mounting seat according to the present application;

FIG. 7 is a simplified schematic structural diagram of the hot end according to the present application; and

FIG. 8 is a third exploded structural diagram of the three-dimensional printing apparatus according to the present application.

Reference signs used in the figures:

1: extruder; 11: mounting area; 12: connection end; 13: body; 14: connecting member; 111: mounting space; 121: first connection portion; 122: second connection portion; 142: first engaging structure; 143: second engaging structure;

2: hot end; 21: engagement portion; 22: heat dissipation portion; 23: heating portion; 24: nozzle; 25: connection area; 214: positioning hole; 221: heat dissipation frame; 222: heat dissipation body; 2211: connection hole;

3: positioning member; and

4: mounting seat.

### DESCRIPTION OF EMBODIMENTS

The technical solutions in the embodiments of the present application will be clearly and completely described below with reference to the accompanying drawings in the embodiments of the present application. Apparently, the described embodiments are merely some rather than all of the embodiments of the present application. All other embodiments obtained by those skilled in the art based on the embodiments of the present application without making creative efforts shall fall within the scope of protection of the present application. Moreover, it should be understood that the embodiments described herein are merely intended to explain rather than limit the present application. In the present application, unless otherwise stated, directional terms such as “up”, “down”, “left”, and “right” generally refer to the actual operational or working orientations of a device, specifically corresponding to the directions in the accompanying drawings.

In the present application, unless otherwise expressly specified and defined, terms such as “connected”, “connection”, and “stacked” shall be understood in a broad sense. For example, a connection may be a fixed connection, a detachable connection, or an integral connection; or it may be a direct connection or an indirect connection via an intermediate medium; or it may be a connection between two elements or an interaction between two elements. For a person of ordinary skill in the art, the specific meanings of the foregoing terms in the present application may be understood based on specific situations.

The present application provides a three-dimensional printing apparatus, which will be described in detail below. It should be noted that the description order of the following embodiments is not intended to limit the preferred order of the embodiments of the present application. Furthermore, in the following embodiments, the description of each embodiment has its own focus. For parts not described in detail in a certain embodiment, reference may be made to the relevant descriptions in other embodiments.

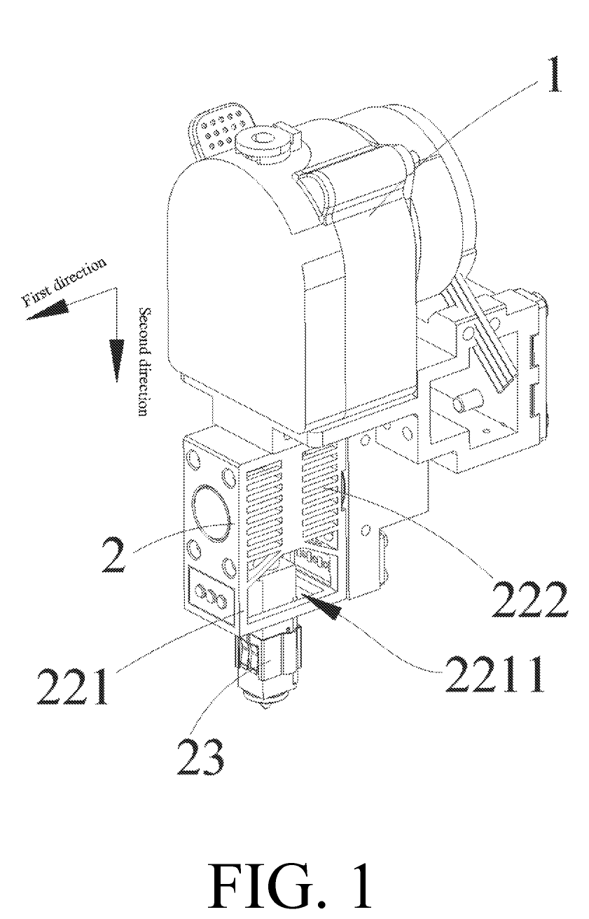

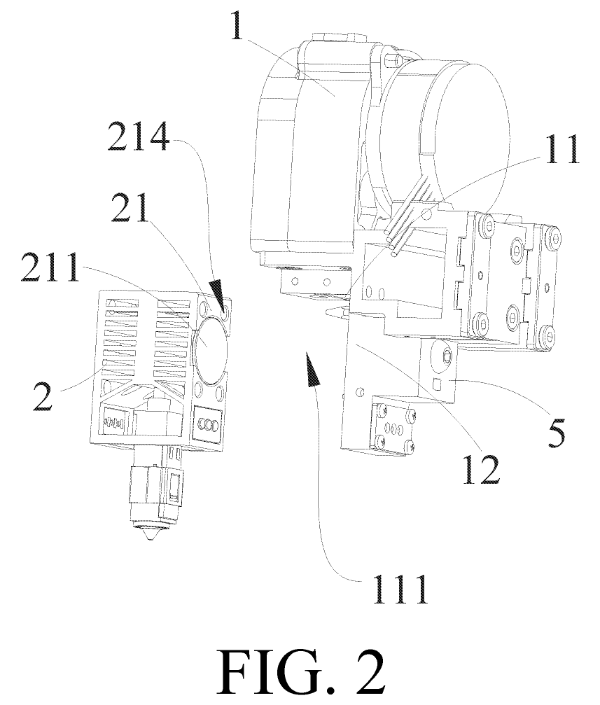

According to an embodiment in a first aspect of the present application, referring to FIGS. 1, 2, and 3, a three-dimensional printing apparatus is used for printing different materials. The different materials are classified based on their properties. The properties of the materials may be color, melting temperature, or composition.

The three-dimensional printing apparatus includes an extruder 1 formed with a feed channel and provided with a mounting area 11.

The three-dimensional printing apparatus further includes different hot ends 2, each formed with a discharge channel for accommodating a material and provided with an engagement portion 21, where the engagement portion 21 is adapted to the mounting area 11 of the extruder 1, and the engagement portions 21 of the different hot ends 2 are detachably connected to the mounting area 11, so that the feed channel of the extruder 1 is respectively communicated with the discharge channels of at least two of the hot ends 2, thereby enabling the extruder 1 to convey the material into the discharge channels of the hot ends 2.

For the hot ends in the embodiment of the present application, the engagement portions 21 of the different hot ends 2 can be detachably connected to the mounting area 11 of the extruder 1 respectively. The different hot ends 2 can meet different requirements, for example, the different hot ends 2 can accommodate different materials, or the discharge channels of the different hot ends 2 may have different apertures. Thereby, the hot ends 2 connected to the extruder 1 can meet different requirements during a multi-dimensional printing process. That is to say, the present application, by providing at least two different hot ends 2 and making the extruder 1 detachably connected to the at least two hot ends respectively, enables the feed channels of different extruders 1 to automatically communicate with the discharge channels of the different hot ends 2 respectively, i.e., the extruder 1 can be used in conjunction with the different hot ends 2 to meet different requirements during a multi-dimensional printing process, which is advantageous for reducing the cost of multi-dimensional printing.

It is understandable that arranging the connecting member 14 at the mounting area 11 achieves effective utilization of the space in the mounting area 11, which is beneficial for structural simplification of the three-dimensional printing tool head assembly. Furthermore, since the hot end 2 will be arranged at the mounting area 11, arranging the connecting member 14 also at the mounting area 11 allows the connecting member 14 to directly and fixedly connect the hot end 2 and the extruder 1 together when the hot end 2 is at the mounting area 11. This improves the convenience of using the connecting member 14 to connect the hot end 2 and the extruder 1, which in turn facilitates simplifying the structure of the connecting member 14.

It is understandable that in existing technologies, if only a single tool head is equipped, during switching from material A to material B, the residual material A needs to be removed first, resulting in a waste of material.

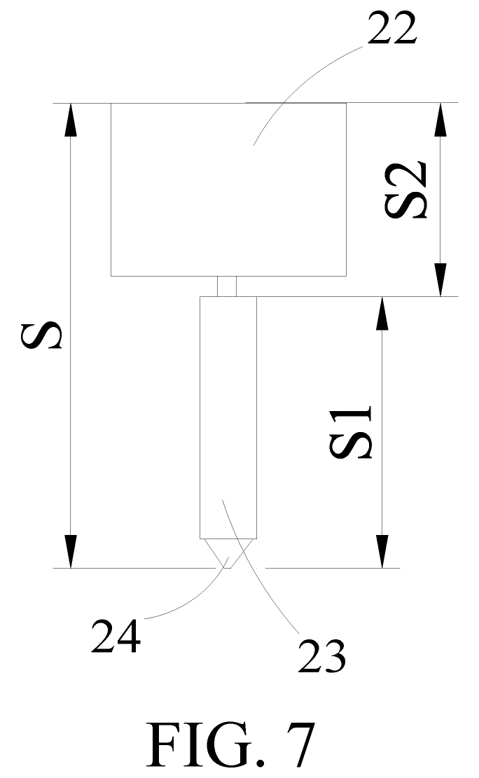

In the present application, as shown in FIG. 7, the hot end 2 includes a heat dissipation portion 22 and a heating portion 23 connected sequentially. The discharge channel includes a second channel formed in the heat dissipation portion 22 and a first channel formed in the heating portion 23, with the first channel and the second channel being in communication. The length of the first channel is S1. The length of the second channel is S2. In existing technologies, the method of switching feed materials through a single tool head requires removing the remaining material from the hot end 2 each time, resulting in a wasted material length of S = S1 + S2. In the present application, during switching of materials, only the hot end 2 corresponding to the extruder 1 needs to be individually replaced. Furthermore, the material within the second channel of the hot end 2 is typically in a fluid state. Therefore, when the hot end 2 corresponding to the extruder 1 is individually replaced in the present application, the wasted material length is less than S1, or it is only necessary to remove the material from the second channel through the first channel. Consequently, the wasted material length generated each time one hot end 2 is replaced in the present application is S1. Thus, the three-dimensional printing apparatus of the present application is advantageous for reducing the cost of multi-dimensional printing and the waste of material, and enables the cost and the waste of material to be maintained in a relatively balanced state. It should be noted that, due to the different melting temperatures of various materials, if switching from a high-temperature material to a low-temperature material, for example, switching from a material with a melting temperature of 250° to one with a melting temperature of 200°, the method of switching feed materials using a single tool head in existing technologies can cause the 250° material to clog within the same hot end. The method of the present application can avoid such issues, meeting the working conditions for simultaneous printing with multiple materials at multiple temperatures, as well as printing with multiple hot end nozzle apertures.

In some examples, multi-dimensional printing is, for example, 3D printing.

In some embodiments, referring to FIGS. 1, 2, and 3, the extruder 1 includes a body 13 and a connecting member 14, where the connecting member 14 is arranged at the mounting area 11, and when the hot end 2 is located at the mounting area 11, the connecting member 14 is configured to fixedly connect the hot end 2 and the extruder 1.

It is understandable that this fixedly connects the hot end 2 and the body 13, thereby achieving the connection between the hot end 2 and the extruder 1, and ensuring stable communication between the feed channel of the extruder 1 and the discharge channel of the hot end 2. Arranging the connecting member 14 at the mounting area 11 achieves effective utilization of the space in the mounting area 11, which is beneficial for structural simplification of the three-dimensional printing tool head assembly. Furthermore, since the hot end 2 will be arranged at the mounting area 11, arranging the connecting member 14 also at the mounting area 11 allows the connecting member 14 to directly and fixedly connect the hot end 2 and the extruder 1 together when the hot end 2 is at the mounting area 11. This improves the convenience of using the connecting member 14 to connect the hot end 2 and the extruder 1, which in turn facilitates simplifying the structure of the connecting member 14.

In some examples, the connecting member 14 is, for example, a magnetic member, a snap-fit member, or an adhesive member.

Exemplarily, when the connecting member 14 is a snap-fit member, the snap-fit member is fixedly connected to the body 13 and can engage in a snap-fit cooperation with the hot end 2. Specifically, the hot end 2 is formed with a snap-fit groove adapted to the snap-fit member. Engaging the snap-fit groove of the hot end 2 with the snap-fit member achieves a snap-fit connection between the snap-fit member and the hot end 2, thereby realizing the connection between the hot end 2 and the extruder 1. When the hot end 2 is removed, by applying a force to the hot end 2 away from the snap-fit member or applying a force to the snap-fit member away from the hot end 2, the snap-fit member and the hot end 2 are caused to separate, allowing the hot end 2 to move relative to the extruder 1.

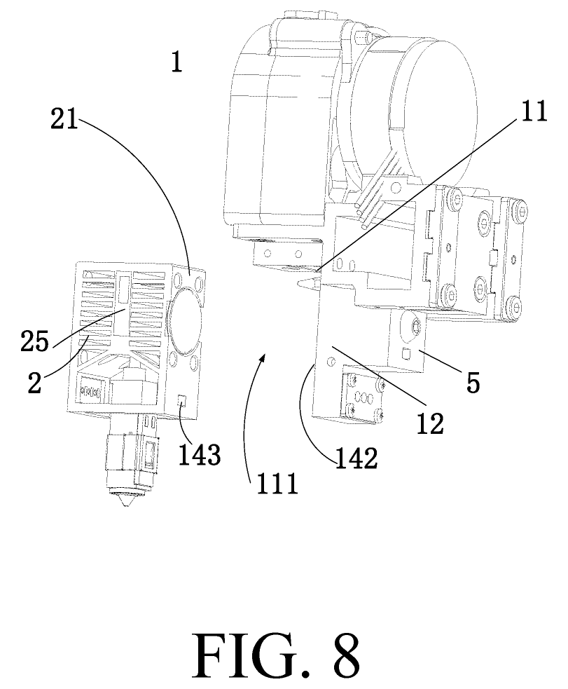

In some embodiments, referring to FIG. 8, the connecting member 14 includes a first engaging structure 142, and the hot end 2 is formed with a second engaging structure 143. The first engaging structure 142 and the second engaging structure 143 are engaged in a snap-fit cooperation to fixedly connect the hot end 2 and the body 13.

It is understandable that when it is necessary to connect the hot end 2 and the body 13, the snap-fit cooperation between the first engaging structure 142 and the second engaging structure 143 causes them to be connected together, thereby fixedly connecting the hot end 2 and the body 13 together. This achieves a snap-fit connection between the hot end 2 and the extruder 1. When the hot end 2 needs to be disassembled, by causing the first engaging structure 142 and the second engaging structure 143 to disengage, the hot end 2 is allowed to move relative to the body 13, thereby enabling the disassembly of the hot end 2. This allows the hot end 2 to be detachably connected to the extruder 1, facilitating the assembly and disassembly of the hot end 2.

In some examples, one of the first engaging structure 142 and the second engaging structure 143 is an engaging post, and the other of the first engaging structure 142 and the second engaging structure 143 is an engaging hole.

In some embodiments, referring to FIGS. 1, 2, and 3, the extruder 1 is provided with a connection end 12 for connecting with the hot end 2, the mounting area 11 includes a mounting space 111 formed at the connection end 12 of the extruder 1, and a shape of the engagement portion 21 is adapted to the mounting space 111. Being adapted can mean that the shape and/or size of the engagement portion 21 corresponds to the mounting space 111. The engagement portion 21 is accommodated within the mounting space 111.

It is understandable that by forming the mounting space 111 at the connection end 12 of the extruder 1, the hot end 2 with the engagement portion 21 adapted in shape to the mounting space 111 can be arranged within the mounting space 111, ensuring that the hot end 2 can be connected to the extruder 1.

It is understandable that the shapes of the engagement portions 21 of the different hot ends 2 are all adapted to the mounting space 111.

Specifically, referring to FIGS. 1, 2, and 3, the connection end 12 includes a first connection portion 121 and a second connection portion 122 connected sequentially, the first connection portion 121 extends along a first direction, the second connection portion 122 extends along a second direction, the first direction and the second direction intersect, and the mounting space 111 is formed between the first connection portion 121 and the second connection portion 122.

It is understandable that a first end of the first connection portion 121 is connected to a first end of the second connection portion 122, a second end of the first connection portion 121 extends along the first direction, and a second end of the second connection portion 122 extends along the second direction. There is an angle greater than 0° between the extension direction of the second end of the first connection portion 121 and the extension direction of the second end of the second connection portion 122. Consequently, the mounting space 111 is formed between the second end of the first connection portion 121 and the second end of the second connection portion 122, allowing the hot end 2 to be accommodated within the mounting space 111.

It is understandable that the shape of at least one of the first connection portion 121 and the second connection portion 122 is adapted to the shape of the engagement portion 21 of the hot end 2, ensuring that the hot end 2 can be adapted to the connection end 12 of the extruder 1 and thereby achieving the connection between the hot end 2 and the extruder 1. In some examples, the shape of a side of the first connection portion 121 facing the hot end 2 is adapted to the shape of the engagement portion 21, enabling the engagement portion 21 of the hot end 2 to be matched and connected with the first connection portion 121. Exemplarily, the feed channel of the extruder 1 is formed at the first connection portion 121. When the engagement portion 21 docks with the first connection portion 121, the discharge channel of the hot end 2 and the feed channel of the extruder 1 are in communication.

In some examples, the mounting area 11 may also refer to a mounting surface formed on the extruder 1. The shape of the mounting surface is adapted to the shape of the engagement portion 21, enabling the engagement portion 21 to cooperate with the mounting surface to achieve the connection between the hot end 2 and the extruder 1.

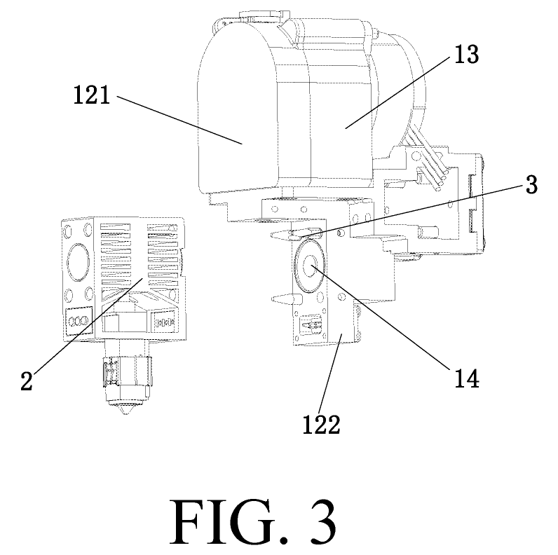

In some embodiments, referring to FIG. 3, the three-dimensional printing apparatus further includes at least one positioning member 3, the positioning member 3 is arranged at the mounting area 11 and is configured to position the engagement portion 21 to allow the engagement portion 21 to cooperate with and be fixed to the mounting area 11, the engagement portion 21 is formed with a positioning hole 214, and the positioning member 3 is insertable into the positioning hole 214 to position and fix the engagement portion 21.

It is understandable that when the hot end 2 is connected to the mounting area 11, the positioning member 3 can position the engagement portion 21 of the hot end 2, allowing the engagement portion 21 of the hot end 2 to properly cooperate with the mounting area 11 of the extruder 1, thereby achieving the connection between the hot end 2 and the extruder 1. By forming the engagement portion 21 with the positioning hole 214 adapted to the positioning member 3, the positioning member 3 can be inserted into the engagement portion 21 to achieve the positioning of the engagement portion 21.

In some examples, the positioning member 3 is, for example, a positioning pin, a positioning plate, or any other suitable structural member with a positioning function.

In some embodiments, nozzles 24 of the different hot ends 2 have different apertures.

It is understandable that the different hot ends 2 can be detachably connected to the extruder 1 respectively. Therefore, by using the different hot ends 2, the aperture of the nozzle 24 of the three-dimensional printing tool head assembly can be changed, which can meet different requirements in a multi-dimensional printing process and is advantageous for reducing the cost of multi-dimensional printing.

In some embodiments, at least one of the feed channel and the discharge channel is a linear channel.

It is understandable that setting the feed channel and/or the discharge channel as a linear channel makes it less likely for the material to clog when moving within the feed channel and/or the discharge channel.

It is understandable that the linear channel refers to a channel that extends in a straight direction without any bends.

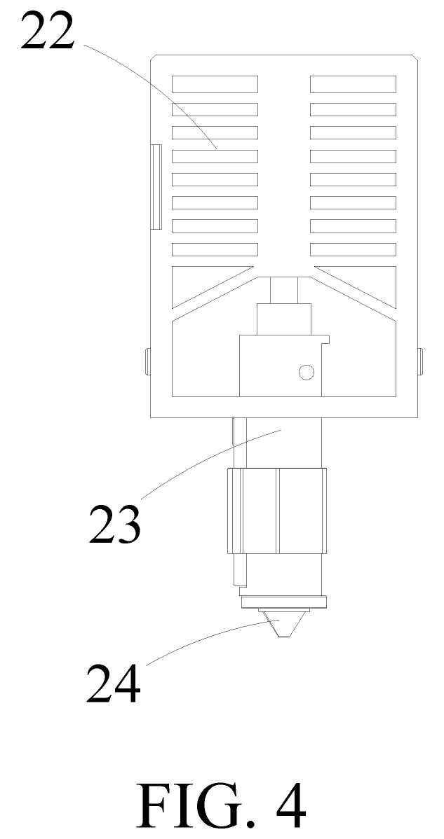

In some embodiments, referring to FIG. 4, the hot end 2 includes a heating portion 23 and a nozzle 24 connected sequentially, the discharge channel includes a first channel formed in the heating portion 23, and the first channel communicates the nozzle 24 with the feed channel.

It is understandable that the first channel of the heating portion 23 communicates the feed channel with the nozzle 24, allowing the material to enter the first channel through the feed channel. At this point, the heating portion 23 can heat the material within the first channel, bringing the material to a preset temperature, and then the material is expelled through the nozzle 24.

In some embodiments, referring to FIG. 4, the hot end 2 further includes a heat dissipation portion 22, the heat dissipation portion 22, the heating portion 23, and the nozzle 24 are connected sequentially, the discharge channel further includes a second channel formed in the heat dissipation portion 22, and the second channel and the first channel are in communication. As shown in FIG. 7, the length of the second channel is S2. The length of the first channel is S1.

It is understandable that the extruder 1 conveys the material into the second channel, and then the material is conveyed into the first channel. At this point, the heating portion 23 can heat the material, bringing the material to a preset temperature, so that the nozzle 24 can expel the material.

It is understandable that in existing technologies, the method of reducing cost by switching feed materials through a single tool head, during switching, requires removing the residual material inside the hot end 2. This results in a waste of material from both the second channel and the first channel, with the wasted material length being S1 + S2 = S. In contrast, the present application, by arranging at least two hot ends 2, allows for directly and individually replacing one hot end 2 when different materials need to be used. The wasted material length is less than S1, or it is only necessary to expel the material from the second channel through the first channel. Therefore, the wasted material length generated each time one hot end 2 is replaced in the present application is S1, effectively reducing the waste of material. Furthermore, due to the different melting temperatures of various materials, if switching from a high-temperature material to a low-temperature material, for example, switching from a material with a melting temperature of 250° to one with a melting temperature of 200°, the method of switching feed materials using a single tool head in existing technologies can cause the 250° material to clog within the same hot end. The method of the present application can avoid such issues, meeting the working conditions for simultaneous printing with multiple materials at multiple temperatures, as well as printing with multiple hot end nozzle apertures.

In some embodiments, referring to FIGS. 1 and 4, the heat dissipation portion 22 includes a heat dissipation frame 221 and a heat dissipation body 222, the heat dissipation body 222 is installed on the heat dissipation frame 221, the heat dissipation frame 221 is formed with a connection hole 2211, a first end of the heating portion 23 is connected to the heat dissipation body 222, a second end of the heating portion 23 passes through the connection hole 2211 and protrudes beyond the heat dissipation frame 221, and the connection hole 2211 limits and guides the heating portion 23 to communicate and align the first channel with the second channel.

It is understandable that by forming the connection hole 2211 at the heat dissipation frame 221, the heating portion 23 can be connected to the heat dissipation body 222 through the connection hole 2211, improving the convenience of connecting the heating portion 23 and the heat dissipation portion 22. At the same time, after the first end of the heating portion 23 is connected to the heat dissipation body 222, the second end of the heating portion 23 can pass through the connection hole 2211 and protrude beyond the heat dissipation frame 221. This ensures that the second end of the heating portion 23 can protrude beyond the heat dissipation portion 22, facilitating the connection between the heating portion 23 and the nozzle 24. Furthermore, the connection hole 2211 can also serve to limit and guide the heating portion 23, aiding in the alignment of the second channel with the first channel.

Specifically, the heating portion 23 is detachably connected to the heat dissipation frame 221.

It is understandable that by detachably connecting the heating portion 23 to the heat dissipation frame 221, the heating portion 23 can be assembled/disassembled relative to the heat dissipation portion 22. Consequently, when a malfunction occurs in the heating portion 23 or the heat dissipation portion 22, it facilitates the replacement of the heating portion 23 or the heat dissipation portion 22. Simultaneously, when cleaning the second channel of the heat dissipation portion 22 and the first channel of the heating portion 23, the heating portion 23 can be disassembled, thereby making it easier to clean the second channel and the first channel.

In some examples, the heating portion 23 is detachably connected to the heat dissipation frame 221 by means of snap-fitting, magnetic attraction, or adhesion.

According to an embodiment in a second aspect of the present application, the present application further provides a three-dimensional printing apparatus for printing the same material. The embodiment in the second aspect differs from the embodiment in the first aspect as follows: at least two hot ends 2 are arranged, each formed with a discharge channel; the apertures of the discharge channels of different hot ends 2 are different; the discharge channels of different hot ends 2 are configured to accommodate the same material; each hot end 2 is provided with an engagement portion 21 adapted to the mounting area 11; and the mounting area 11 is respectively detachably connected to at least two engagement portions 21, so that the feed channel of the extruder 1 is respectively communicated with the discharge channels of at least two hot ends 2, thereby enabling the extruder 1 to convey the same material into the discharge channels of the hot ends 2 with different apertures. That is to say, to meet printing requirements, the same material can be accommodated in the hot ends with different apertures to satisfy the working conditions for printing with multiple hot end nozzle apertures simultaneously.

It is understandable that the engagement portions 21 of different hot ends 2 can be detachably connected to the mounting area 11 of the extruder 1 respectively, and the apertures of the discharge channels of different hot ends 2 are different. Consequently, by connecting the hot end 2 to another extruder 1, the discharge aperture of the three-dimensional printing tool head assembly can be changed, meeting different requirements for discharge apertures during multi-dimensional printing, which is advantageous for reducing the cost of multi-dimensional printing.

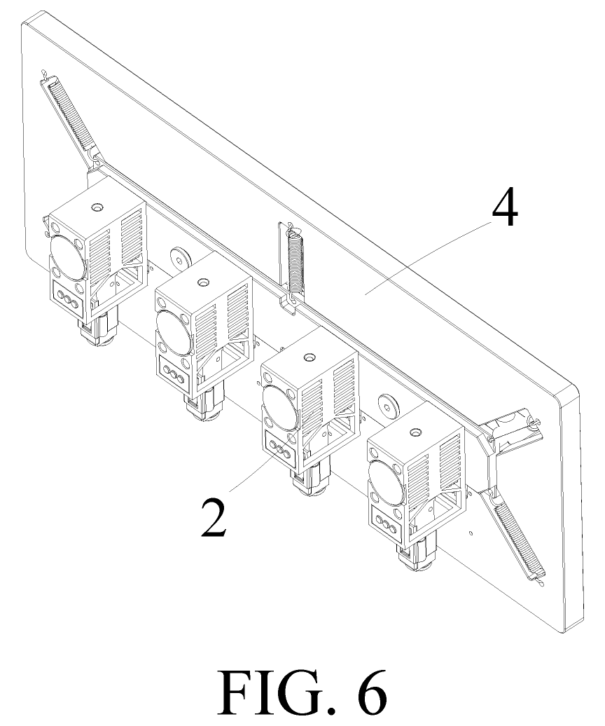

In some embodiments, referring to FIG. 6, the three-dimensional printing apparatus further includes a mounting seat 4, and the mounting seat 4 is detachably installed with at least two hot ends 2.

It is understandable that the mounting seat 4 can be configured to store the hot ends 2. When it is necessary to replace the hot end 2 connected to the extruder 1, the hot end 2 connected to the extruder 1 can be detached and installed onto the mounting seat 4, while simultaneously taking a new hot end 2 from the mounting seat 4 and connecting it to the extruder 1, thereby completing the replacement of the hot end 2 for the three-dimensional printing tool head assembly, which is simple and convenient. Furthermore, the mounting seat 4 serves to organize the hot ends 2, facilitating the storage of unused hot ends 2. After the hot end 2 is connected to the extruder 1, the hot end 2 and the extruder 1 can also be installed together on the mounting seat 4. Here, the hot end 2 and the extruder 1 together can constitute a printing tool head.

The above provides a detailed introduction to the three-dimensional printing apparatus provided by the present application. Specific examples are used herein to illustrate the principles and implementation manners of the present application. The description of the above embodiments is merely intended to aid in understanding the method and core concepts of the present application. Meanwhile, for a person of ordinary skill in the art, based on the concepts of the present application, there may be modifications in the specific implementation manners and scope of application. In summary, the content of the specification should not be construed as limiting the present application.

What is claimed is:

1. A three-dimensional printing apparatus, comprising:
an extruder formed with a feed channel and provided with a mounting area; and
at least two hot ends, each formed with a discharge channel for accommodating a material and provided with an engagement portion, wherein the engagement portion is adapted to the mounting area of the extruder, and the engagement portions of the different hot ends are detachably connected to the mounting area, so that the feed channel of the extruder is respectively communicated with the discharge channels of the at least two hot ends, thereby enabling the extruder to convey the material into the discharge channels of the hot ends.

2. The three-dimensional printing apparatus of claim 1, wherein the extruder is provided with a connection end for connecting with the hot end, the mounting area comprises a mounting space formed at the connection end of the extruder, a shape of the engagement portion is adapted to the mounting space, and the engagement portion is accommodated within the mounting space.

3. The three-dimensional printing apparatus of claim 2, wherein the connection end comprises a first connection portion and a second connection portion connected sequentially, the first connection portion extends along a first direction, the second connection portion extends along a second direction, the first direction and the second direction intersect, and the mounting space is formed between the first connection portion and the second connection portion.

4. The three-dimensional printing apparatus of claim 2, wherein the extruder comprises a connecting member, the connecting member is arranged at the mounting area, and when the hot end is located at the mounting area, the connecting member is configured to fixedly connect the hot end and the extruder.

5. The three-dimensional printing apparatus of claim 1, wherein the three-dimensional printing apparatus further comprises at least one positioning member, the positioning member is arranged at the mounting area and is configured to position the engagement portion to allow the engagement portion to cooperate with and be fixed to the mounting area, the engagement portion is formed with a positioning hole, and the positioning member is insertable into the positioning hole to position and fix the engagement portion.

6. The three-dimensional printing apparatus of claim 2, wherein the three-dimensional printing apparatus further comprises at least one positioning member, the positioning member is arranged at the mounting area and is configured to position the engagement portion to allow the engagement portion to cooperate with and be fixed to the mounting area, the engagement portion is formed with a positioning hole, and the positioning member is insertable into the positioning hole to position and fix the engagement portion.

7. The three-dimensional printing apparatus of claim 3, wherein the three-dimensional printing apparatus further comprises at least one positioning member, the positioning member is arranged at the mounting area and is configured to position the engagement portion to allow the engagement portion to cooperate with and be fixed to the mounting area, the engagement portion is formed with a positioning hole, and the positioning member is insertable into the positioning hole to position and fix the engagement portion.

8. The three-dimensional printing apparatus of claim 4, wherein the three-dimensional printing apparatus further comprises at least one positioning member, the positioning member is arranged at the mounting area and is configured to position the engagement portion to allow the engagement portion to cooperate with and be fixed to the mounting area, the engagement portion is formed with a positioning hole, and the positioning member is insertable into the positioning hole to position and fix the engagement portion.

9. The three-dimensional printing apparatus of claim 1, wherein nozzles of the different hot ends have different apertures.

10. The three-dimensional printing apparatus of claim 1, wherein at least one of the feed channel and the discharge channel is a linear channel.

11. The three-dimensional printing apparatus of claim 1, wherein the hot end comprises a heating portion and a nozzle connected sequentially, the discharge channel comprises a first channel formed in the heating portion, and the first channel communicates the nozzle with the feed channel.

12. The three-dimensional printing apparatus of claim 11, wherein the hot end further comprises a heat dissipation portion, the heat dissipation portion, the heating portion, and the nozzle are connected sequentially, the discharge channel further comprises a second channel formed in the heat dissipation portion, and the second channel and the first channel are in communication.

13. The three-dimensional printing apparatus of claim 12, wherein the heat dissipation portion comprises a heat dissipation frame and a heat dissipation body, the heat dissipation body is installed on the heat dissipation frame, the heat dissipation frame is formed with a connection hole, a first end of the heating portion is connected to the heat dissipation body, a second end of the heating portion passes through the connection hole and protrudes beyond the heat dissipation frame, and the connection hole limits and guides the heating portion to communicate and align the first channel with the second channel.

14. The three-dimensional printing apparatus of claim 13, wherein the heating portion is detachably connected to the heat dissipation frame.
